(19) United States
(12) Patent Application Publication
(10) Pub. No.: US 2014/0046477 A1
(43) Pub. Date: Feb. 13, 2014

(54) AUTOMATIC ON-CNC TOOL FOR MOTION ANALYSIS AND OPTIMIZATION

(71) Applicants: Peter Vincent Brahan, North Sutton, NH (US); Guy Best, Bethel, VT (US); Gregory S. Wilson, Newbury, NH (US)

(72) Inventors: Peter Vincent Brahan, North Sutton, NH (US); Guy Best, Bethel, VT (US); Gregory S. Wilson, Newbury, NH (US)

(73) Assignee: HYPERTHERM, INC., Hanover, NH (US)

(21) Appl. No.: 13/963,360

(22) Filed: Aug. 9, 2013

Related U.S. Application Data
(60) Provisional application No. 61/681,963, filed on Aug. 10, 2012.

(51) Int. Cl. G05B 13/02

(52) U.S. Cl. CPC G05B 13/024
USPC 700/170

(57) ABSTRACT

The invention features, in one aspect, a computerized method for measuring or improving performance of a cutting head of an automated cutting system by evaluating motor control processing of an automated motion control of the cutting head of the automated cutting system. The method includes generating one or more motor outputs for the automated cutting system for any of a cut, a trace, or a motion, the one or more motor outputs corresponding to at least a portion of a set of motor output commands. A characteristic is measured of the one or more motor outputs for the plurality of axes of the automated cutting system. The characteristic is compared with the at least a portion of the set of motor output commands to determine a performance measurement of the automated cutting system.

### CROSS-REFERENCE TO RELATED APPLICATION

This application claims the benefit of and priority to U.S. Provisional Patent Application No. 61/681,963 filed on Aug. 10, 2012, which is owned by the assignee of the instant application and the disclosure of which is incorporated herein by reference in its entirety.

### FIELD OF THE INVENTION

The invention relates generally to automated cutting systems. More specifically, the invention relates to methods and devices for measuring or improving performance of automated cutting systems.

### BACKGROUND OF THE INVENTION

Cutting systems e.g., plasma arc systems, laser cutting systems, water, et cutting systems, oxy-fuel cutting systems, etc.) can be used for cutting a variety of materials (e.g., metallic, stone or otherwise). More advanced systems can be automated for automatically cutting materials. Although automated systems provide advantages over their manual counterparts, their cut accuracy may be compromised because of component defects/inconsistencies, machine imperfections, component deterioration, and so forth. Current methods for determining cut accuracy for these systems are typically expensive and time consuming.

### SUMMARY OF THE INVENTION

The invention features, in one aspect, a computerized method fir measuring or improving performance of a cutting head of an automated cutting system by evaluating motor control processing of an automated motion control of the cutting head of the automated cutting system. The method comprises the steps of loading, into a data memory, a set of one or more motor output commands for a plurality of axes of the automated cutting system; generating one or more motor outputs for the automated cutting system using a first data processor in communication with the data memory, for any of a cut, a trace, or a motion, the one or more motor outputs corresponding to at least a portion of the set of motor output commands; measuring, using a second data processor, a characteristic of the one or more motor outputs for the plurality of axes of the automated cutting system; comparing, using a third data processor, the characteristic with the at least a portion of the set of motor output commands; and determining, with a fourth data processor, a performance measurement of the automated cutting system for evaluating motor control performance thereof, wherein the performance measurement is determined using the comparison of the characteristic and the set of motor output commands. In related embodiments, the performance measurement is used to generate an indicia of a capability of the automated cutting system to perform a desired function.

In some embodiments, the method involves adjusting one or more of the motor outputs for the automated cutting system to reduce a deviation between the motor output characteristic and the one or more output commands defined by the part data. In related embodiments, the method involves compensating for a deviation between the motor output characteristic and the one or more output commands by modifying one or more parameters of the automated cutting system. In further related embodiments, the one or more parameters include any of (i) a cutting head timing, (ii) process settings, (iii) mechanical settings, (iv) drive and motion settings; and (v) nest program settings.

In some embodiments, the motor output characteristic corresponds to any of (i) an acceleration of the cutting head, (ii) a velocity of the cutting head, (iii) a jerk of the cutting head, (iv) a rotation of the cutting head, and (v) a tilt of the cutting head. In related embodiments, the set of motor output commands are based upon any of (i) a maximum performance of the cutting head, (ii) an average performance of the cutting head, (iii) a desired performance of the cutting head, and (iv) a user-defined performance set. In further related embodiments, the plurality of axes comprises 3, 4, 5 or 6 (or additional) axes.

In some embodiments, the method involves displaying to a user, via a graphical user interface, any of (i) the performance measurement and (ii) the indicia of the capability of the automated cutting system to perform the desired function. In some embodiments, the first data processor, second data processor, third data processor and fourth data processor are embodied in a single data processor or a single computing device.

In another aspect, the invention features a computer readable product, tangibly embodied on non-transitory computer readable medium or a machine-readable storage device and operable on a digital signal processor, for measuring or improving performance of a cutting head of an automated cutting system by evaluating motor control processing of an automated motion control of the cutting head of the automated cutting system, the computer readable product including instructions operable to cause the digital signal processor to receive, by the non-transitory computer readable medium or the machine-readable storage device, a set of one or more motor output commands for a plurality of axes of the automated cutting system; generate, by the non-transitory computer readable medium or the machine-readable storage device, one or more motor outputs for the automated cutting system for any of a cut, a trace, or a motion, the one or more motor outputs corresponding to at least a portion of the set of motor output commands; measure, by the non-transitory computer readable medium or the machine-readable storage device, a characteristic of the one or more motor outputs for the plurality of axes of the automated cutting system; compare, by the non-transitory computer readable medium or the machine-readable storage device, the motor output characteristic with the at least a portion of the set of motor output commands; and determine, by the non-transitory computer readable medium or the machine-readable storage device, a performance measurement of the automated cutting system for enhancing motor control performance thereof, wherein the performance measurement is determined using the comparison of the motor output characteristic and the set of motor output commands. In related embodiments, the performance measurement is analyzed, by the non-transitory computer readable medium or the machine-readable storage device, to generate an indicia of a capability of the automated cutting system to perform a desired function.

In some embodiments, the non-transitory computer readable medium or the machine-readable storage device includes a tuning tool configured to modify operation of the automated cutting system to compensate for variances between the set of motor output commands and the measured motor output characteristic. In related embodiments, the computer readable product further comprises instructions to cause the digital data processor to analyze, by the non-transitory computer readable medium or the machine-readable storage device, the comparison of the motor output characteristic and the set of motor output commands to determine any of (i) a mechanical stability of the cutting head, and (ii) an ability of the cutting head to achieve a desired acceleration or velocity along one or more of the axes.

In another aspect, the invention features a data processing system for measuring or improving performance of a cutting head of an automated cutting system by evaluating motor control processing of an automated motion control of the cutting head of the automated cutting system, comprising a data memory coupled to at least one computing device, wherein the data memory stores a set of one or more motor output commands for a plurality of axes of the automated cutting system; a calibration engine that executes on the at least one computing device, wherein the calibration engine generates one or more motor outputs for the automated cutting system using a first data processor in communication with the data memory, for any of a cut, a trace, or a motion, the one or more motor outputs corresponding to at least a portion of the set of motor output commands; measures a characteristic of the one or more motor outputs for the plurality of axes of the automated cutting system; compares the characteristic with the at least a portion of the set of motor output commands; and determines a performance measurement of the automated cutting system for evaluating motor control performance thereof, wherein the performance measurement is determined using the comparison of the characteristic and the set of motor output commands. In related embodiments, the performance measurement is analyzed to generate an indicia of a capability of the automated cutting system to perform a desired function.

In some embodiments, the calibration engine adjusts one or more of the motor outputs for the automated cutting system to reduce a deviation between the motor output characteristic and the set of one or more motor output commands defined by the part data. In related embodiments, the calibration engine compensates for a deviation between the motor output characteristic and the set of one or more motor output commands defined by the part data. In further related embodiments, the calibration engine compensates for the deviation by modifying one or more values associated with one or more parameters of the automated cutting system. In still further related embodiments, the one or more parameters include any of (i) a cutting head timing, (ii) process settings, (iii) mechanical settings, and (iv) nest program settings.

In some embodiments, the automated cutting system comprises a plasma cutting system, a laser cutting system, an oxy-fuel cutting system, a high temperature thermal cutting system, a drilling system, a punch system, or a fluid jet cutting system.

Other aspects of the invention can become apparent from the following drawings and description, all of which illustrate the principles of the invention, by way of example only.

### BRIEF DESCRIPTION OF THE DRAWINGS

A more complete understanding of the invention can be attained by reference to the drawings identified below.

FIG. 1 depicts a system and environment for measuring or improving performance of a cutting head of an automated cutting system by evaluating motor control processing of an automated motion control of the cutting head, according to an illustrative embodiment of the invention.

FIG. 2 depicts a process for measuring or improving performance of a cutting head of an automated cutting system by evaluating motor control processing of an automated motion control of the cutting head, according to an illustrative embodiment of the invention.

FIG. 3 depicts an exemplary user interface of a computer program for measuring or improving performance of a cutting head of an automated cutting system by evaluating motor control processing of an automated motion control of the cutting head, according to an illustrative embodiment of the invention.

### DETAILED DESCRIPTION OF THE INVENTION

Automated Cutting System and Environment

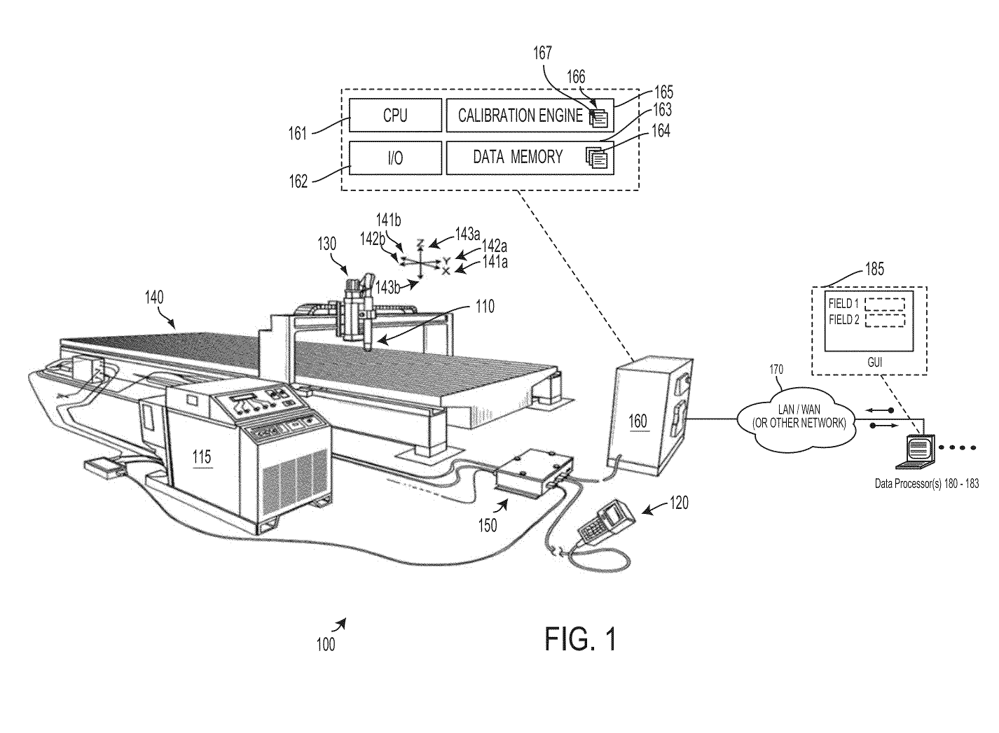

FIG. 1 depicts a system and environment for measuring or improving performance of a cutting head of an automated cutting system by evaluating motor control processing of an automated motion control of the cutting head of the automated cutting system 100, according to an illustrative embodiment of the invention. In order to ensure optimal operation of an automated cutting system, it can be advantageous to measure the performance of the system, and/or make adjustments and/or improvements in order to improve system performance and/or accuracy.

Typically, measuring motion quality for an automated cutting system is difficult, time consuming, and costly. In the illustrated embodiment, generally, the system 100 can, in a timely and cost effective manner, measure machine motion for all axes 141-143 of a cutting table 140, including (but not limited to) X, Y and Z motion, torch height control motion and bevel head motion. This measurement can be completed in a matter of seconds using a standard part program (or routine) or set of part programs (e.g., executed by the analysis tool 165, or “calibration engine,” on the computing device 160). In one embodiment, this measurement data can be used to generate a performance measurement, which can indicate whether the cutting system 100 can perform a desired function (e.g., a cut, trace, motion, etc.). These and other features of the illustrated embodiment are discussed further below.

FIG. 1, more specifically, shows an automated cutting system 100. In the illustrated embodiment, the depicted automatic cutting system 100 is a plasma cutting system, although it can also be a laser cutting system, an oxy-fuel cutting system, a high temperature thermal cutting system, a drilling system, a punch system, a fluid jet cutting system, or other similar cutting that could benefit from the teachings disclosed herein. The system 100 includes a cutting head 110 (e.g., plasma arc torch), an associated power supply/gas supply 115, a remote high-frequency (RHF) console 120, a positioning apparatus 130, a cutting table 140, a cutting head height control 150, and a computing device 160 (e.g., an associated computerized numeric controller (“CNC”)). In some embodiments, one or more remote data processors 180-183 are coupled to the automated cutting system 100 via a network 170.

In the illustrated embodiment, some or all of the components 110-183 can be connected together via network 170 (e.g., a wired network, wireless network, or a combined wired/wireless network). For example, network 170 can be a local area network (LAN), wide area network (WAN), the Internet, or otherwise.

By way of overview, a workpiece (not shown) can be placed on the cutting table 140 and the cutting head 110 (e.g., a plasma arc torch) can be mounted on a positioning apparatus 130, although in some embodiments, a workpiece is not mounted on the cutting table 140, e.g., when performing a motion without any cutting. The positioning apparatus 130 can provide relative motion between the tip of the head 110 and the workpiece to direct the plasma arc or a cutting laser or a liquid jet along a processing path. The computing device 160 can initiate any of a cut, trace, or motion process. As shown in FIG. 1, the computing device 160 (e.g., CNC) can accurately command motion of the cutting head 110 and/or the cutting table 140 to enable the workpiece to be cut to a desired pattern, or the trace or motion to performed to a desired pattern. The computing device 160 is in communication with the positioning apparatus 130. The positioning apparatus 130 uses signals from the computing device 160 to direct the cutting head 110 along a desired cutting, trace or motion path. Position information for cutting head 110 may be returned from the positioning apparatus 130 to the computing device 160 to allow the computing device 160 to operate interactively with the positioning apparatus 130 to obtain an accurate cut, trace or motion path.

In one embodiment, the cutting head 110 for the system 100 generally includes a body, an electrode mounted within the body, passages for cooling fluid and cut and shield gases, a swirl ring to control the fluid flow patterns, a nozzle with a central exit orifice, and electrical connections (not shown). A shield can also be provided around the nozzle to protect the nozzle and to provide a shield gas flow to the area proximate the plasma arc. Gases applied to the torch can be non-reactive (e.g., argon or nitrogen) or reactive (e.g., oxygen or air).

The tip of the cutting head 110 during operation can be positioned proximate the workpiece by the positioning apparatus 130. A pilot arc is generated between the electrode (cathode) and the nozzle (anode) by using, for example, a high frequency, high voltage signal from the RHF console. The pilot arc ionizes gas from the gas console passing through the nozzle exit orifice. As the ionized gas reduces the electrical resistance between the electrode and the workpiece, the arc transfers from the nozzle to the workpiece (e.g., transferred plasma arc mode). The transferred plasma arc mode is characterized by a conductive flow of ionized gas from the electrode to the workpiece, thereby cutting the workpiece.

With continued reference to FIG. 1, the illustrated computing device 160 (e.g., computer numerical controller or “CNC”) can be configured to operate with a plasma arc, laser, oxy fuel, and/or water jet technologies. The computing device 160 can allow a user (e.g., an operator of the automated high temperature thermal cutting system) to manually configure a large number of operating parameters, and can execute a variety of software modules, e.g., the analysis tool 165, as discussed further below.

In the illustrated embodiment, the computing device 160 can be one or more digital signal processors, data processors, desktop computers, servers, laptops, mobile devices, custom computing devices, other computing devices, or any combination thereof, albeit as adapted in accord with the teachings hereof. An exemplary computing device 160 is shown in FIG. 1, including a central processing unit (CPU) 161, input/output (I/O) circuitry 162, a data memory 163 (e.g., RAM), and analysis tool (or, “calibration engine”) 165.

The central processing unit 161 is typically a general-purpose microprocessor or central processing unit and has a set of control algorithms, comprising resident program instructions and calibrations stored in the memory 163 and executed to provide the desired functions. The central processing unit 161 executes functions in accordance with any one of a number of operating systems including proprietary and open source system solutions. In some embodiments, an application program interface (API) is preferably executed by the operating system for computer applications to make requests of the operating system or other computer applications. The description of the central processing unit 161 is meant to be illustrative, and not restrictive to the disclosure, and those skilled in the art would appreciate that the disclosure may also be implemented on platforms and operating systems other than those mentioned.

In some embodiments, the I/O circuitry 162 includes various connection ports for connecting the cutting table 140, the power supply/gas supply 105, the RHF console 120, the positioning apparatus 130, and data processors 180-183.

The data memory 163 is configured to store, access, and modify structured or unstructured data including, for example, motor output commands 164, motor output characteristics 166, standards 167, relational data, tabular data, audio/video data, and graphical data. Those skilled in the art will appreciate that data 164-167 can also be stored elsewhere in the computer device 160, or on separate computing devices (e.g., data processors 180-183).

In the illustrated embodiment, the motor output commands 164 comprise inputs or values instructing the cutting head 110 of the automated system 100 to perform a particular cut, trace or motion. By way of non-limiting example, the motor output commands can be based upon any of (i) a maximum performance of the cutting head, (ii) an average performance of the cutting head, (iii) a desired performance of the cutting head, and (iv) a user-defined performance set. In some embodiments, the motor output commands 164 can be associated with “theoretical” values, e.g., values that the cutting head 110 are supposed to achieve under ideal conditions.

In the illustrated embodiment, the motor output characteristics 165 comprise values (e.g., motor output “feedback” values or otherwise) obtained from the automated cutting system 100 during a cut, trace or motion. In some embodiments, the characteristics 165 can be time-stamped positional measurements for some or all of the axes 141-143 of the system 100. By way of example, the characteristics 166 can correspond to any of (i) an acceleration of the cutting head 110, (ii) a velocity of the cutting head 110, (iii) a jerk of the cutting head 110, (iv) a rotation of the cutting head 110, and (v) a tilt of the cutting head 110. In some embodiments, the characteristics 166 comprise “actual” values obtained during the cut, trace or motion, i.e., as opposed to the “theoretical” values discussed above.

In the illustrated embodiment, the standards 167 can be a set of rule definitions for the cutting head 110, table 140, or system 100. For example, the standards 167 can include an average, optimal, maximum, or user defined performance specification, e.g., for cutting head 110 location, acceleration, velocity, jerk, rotation, tilt, and so forth. The standards 167 can, for example, define an acceptable error (e.g., 2%) for a particular cut, trace or motion. By way of further example, the standards 167 can include, for the cutting head 110 and/or cutting table 140, position accuracy, commanded versus actual position, oscillation while at a steady state, overshoot while accelerating, and so forth.

Analysis Tool (or “Calibration Engine”)

In the illustrated embodiment, the analysis tool 165 executes on computing device 160, and can measure and/or improve the performance of the cutting head 110 of the automated cutting system 100. Generally, the analysis tool 5 can measure the following capabilities of the cutting head 110 and/or cutting table 140:
Dynamic response to a step motion commanded by the CNC 160 to check for mechanical stability in some or all of axes 141-143.
Ability to reach a desired acceleration and velocity in some or all of axes 141-143.
Oscillation while at steady state velocity in some or all of axes 141-143.
Ability to maintained balanced (X and Y axes) motion around a rotated square.
Ability to maintain balanced and smooth motion in some or all axes (table (X,Y), torch height control (Z) and bevel tilt and rotate axes.
Ability to maintain positional accuracy through the most demanding True Hole profile (X and Y axes).
Ability to maintain positional accuracy through the most demanding fine features.
Ability to stay on path and not create any protrusions off path when moving through the most demanding True Hole profile.

The measurement data (e.g., motor output characteristics 166) can be collected onto data memory 163. This data can be used by the analysis tool 165 to compare with a set of standards (e.g., standards 167 and/or commanded inputs 164). This analysis tool 165 can reside on the CNC 160 or be a standalone program (e.g., executing on any of data processors 180-183 or otherwise).

In the illustrated embodiment, each input is associated with two values, namely, a theoretical value (e.g., motor output commands 164) and an actual value (e.g., characteristics 166 of the motor outputs); although in other embodiments there may be a greater or lesser number of such associated values. The theoretical value can be entered into the system (e.g., by a user, a computer executing a table calibration sub-routine, etc.) and can define a value or parameter for a test to be run on the table (see attached Appendices for exemplary tests). The actual value is the value obtained from motor output feedback (or characteristics 166) generated in response to the test performed.

In the illustrated embodiment, the analysis tool 165 can compare the theoretical performance (e.g., commands 164) and the actual performance (e.g., characteristics 166). This comparison can be used to determine a performance measurement of the system 100, or component thereof (e.g., cutting head 110, cutting table 140, computing device 160, etc.). For example, the analysis tool 165 may observe an actual performance that is 0.020″ behind where a theoretical performance indicated that it should be. Accordingly, the analysis tool 165 can command the cutting head 110 to turn off when the commanded position is 0.020″ beyond where it would be for an “ideal” cutting system (e.g., as defined by standards 167 or otherwise). By way of further example, if the cutting head 110, or table 140, move such that certain features are always 0.003″ smaller than required, the analysis tool 165 can command a move that is 0.003″ larger, thus improving the accuracy of the system 100.

The analysis tool 165 can be used, for example, to review data created by running the part programs in the attached Appendices (see attached) using the procedures described herein and the attached Appendices. The analysis tool 165 can take commanded and actual encoder counts at each millisecond, or other prescribed time interval, along with several inputs describing the test parameters and the cutting table design for each axis. The inputs can include, for example, desired table velocity, acceleration, etc. (e.g., as described in Appendix E).

The inputs can then be converted to positional information, analyzed and compared against a set of standards for cutting table performance. By way of non-limiting example, the set of standards can include desired table performance, maximum table performance, average table performance, a user-defined set of standards, and so forth.

In some embodiments, the analysis tool 165 can provide a “grade” in each area (e.g., location, cornering, straight cutting, beveled cutting, etc.) analyzed by the tool 165 (e.g., pass, fail, warning, etc.) or other indicia (e.g., a green light icon for a pass, a red light icon for a fail, an yellow light icon fir a warning, etc.).

In some embodiments, the analysis tool 165 can recommend actions to a user (e.g., machine builder/technician) for areas of improvement, if required. In some embodiments, the analysis tool 165 can automatically adjust settings/parameters in the system 110, or component thereof, to Obtain optimal results (e.g., adjusting kerf values in the nest or part program, compensating for: worn or offset rack teeth, gear slippage, etc.).

The analysis tool 165 can execute, among others, the following tests or measurements:
Velocity and acceleration checks on the rail, transverse, Z-axes, tilt and rotate axes individually
Coordinated dynamic and positional accuracy checks through cutting profiles, including identifying any flat spots in holes or spikes in motion
Coordinated dynamic and positional accuracy checks through cornering profiles or bevel cutting motions.
Acceleration and jerk measurements

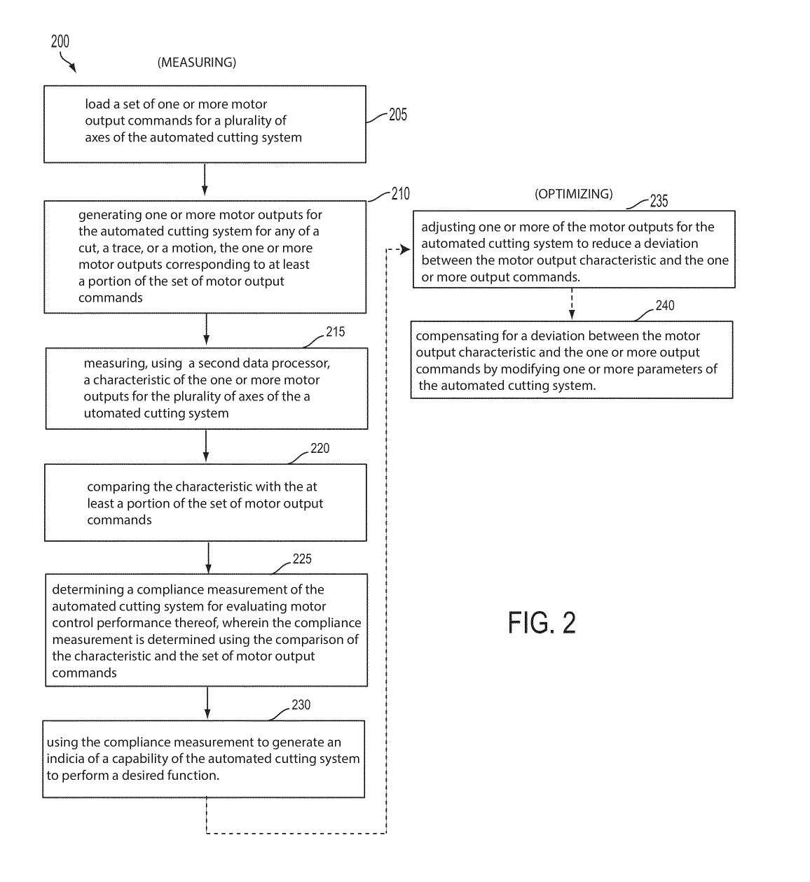

For further details of the analysis tool 165, please see the discussion of FIG. 2 below, and the attached Appendices A-E submitted with the application.

Although the above structure and functionality of the computing device 160 is shown in a single unitary system, it will be appreciated that in some embodiments, such structure and/or functionality can be contained in, or executed on, multiple hardware devices and/or software modules. For example, multiple devices (e.g., computing device 160 and data processors 180-183 executing in a distributed computing environment, such as a “cloud computing” environment or otherwise). Additionally, it will be appreciated that in other embodiments, the functionality of the analysis tool 165 can be contained within one or more other hardware or software modules, e.g., the CPU 161, data processors 180-183, or otherwise.

Remote Data Processors

In some embodiments, remote data processors 180-183 are coupled to the automated cutting system 110 via network 170. The data processors 180-183 can perform a variety of functions that would otherwise be performed by the computing device 160, or they can supplement existing functionality of the computing device 160. For example, in some embodiments, some or all of the features of the analysis tool 165 can be executed on separate ones of the digital data processors 180-183. By way of further example, a user may interact with the automated cutting system 100, or more particularly, with the analysis tool 165 or computing device 160, via a GUI 185 executing on any of the data processors 180-183.

In the illustrated embodiment, remote data processors 180-183 comprise four computing devices (e.g., desktop computer, laptop computer, server computer, tablet device, mobile device, etc.) connected to the automated cutting system 110, or more particularly, to the computing device 160, via network 170, although in practice a greater or lesser number of such devices 180-183 can be used. The GUI 185 can be, for example, a web browser, custom or generic Windows OS application, or other applications designed to display and/or receive input from a user. Although four remote devices 180-183 are shown here, it will be appreciated that in practice a greater or lesser number of such devices 180-183 can be connected to the automated cutting system 100. Further details of the GUI 185 can be found below with reference to FIG. 2.

Process for Measuring and/or Improving Per

FIG. 2 depicts an exemplary process 200 for measuring or improving performance of a cutting head (e.g., cutting head 110) of an automated cutting system (e.g., system 100) by evaluating motor control processing of an automated motion control of the cutting head of the automated cutting system, according to an illustrative embodiment of the invention.

In step 205, a set of one or more motor output commands (e.g., commands 164) for a plurality of axes (e.g., axes 141-143) of the automated cutting system (e.g., system 100) are loaded in a data memory (e.g., data memory 163). In the illustrated embodiment, commands can be loaded by a user, e.g., via GU 185, or they can be loaded automatically, e.g., via a sub-routine executing on the computing device 160, data processors 180-183, or otherwise. By way of example, the commands can be based on (i) a maximum performance of the cutting head, (ii) an average performance of the cutting head, (iii) a desired performance of the cutting head, and (iv) a user-defined performance set, or any combination thereof.

In step 210, one or more motor outputs for the automated cutting system are generated (e.g., using computing device 160) in communication with the data memory, for any of a cut, a trace, or a motion, the one or more motor outputs corresponding to at least a portion of the set of motor output commands. In step 215, a characteristic (e.g., characteristic 166) of the one or more motor outputs for the plurality of axes of the automated cutting system is measured (e.g., using a second data processor 180). In some embodiments, the characteristic(s) are converted into a set of time-stamped positional measurements, the set of positional measurements configured to represent an actual path of the cutting head across the table table 140) and/or workpiece during the cut, trace or motion.

In step 220, the characteristic is compared with the at least a portion of the set of motor output commands (e.g., using a third data processor 181). In some embodiments, the characteristic can be compared against a set of standards (e.g., standards 167 or command signals). In step 225, a performance measurement of the automated cutting system is determined for evaluating motor control performance of the cutting system. For example, the performance measurement can be determined using a fourth data processor 182. In the illustrated embodiment, the performance measurement is determined using the comparison of the characteristic and the set of motor output commands. The performance measurement can be a value, percentage, or other data. In some embodiments, it can represent a deviation between the characteristic and the commanded values.

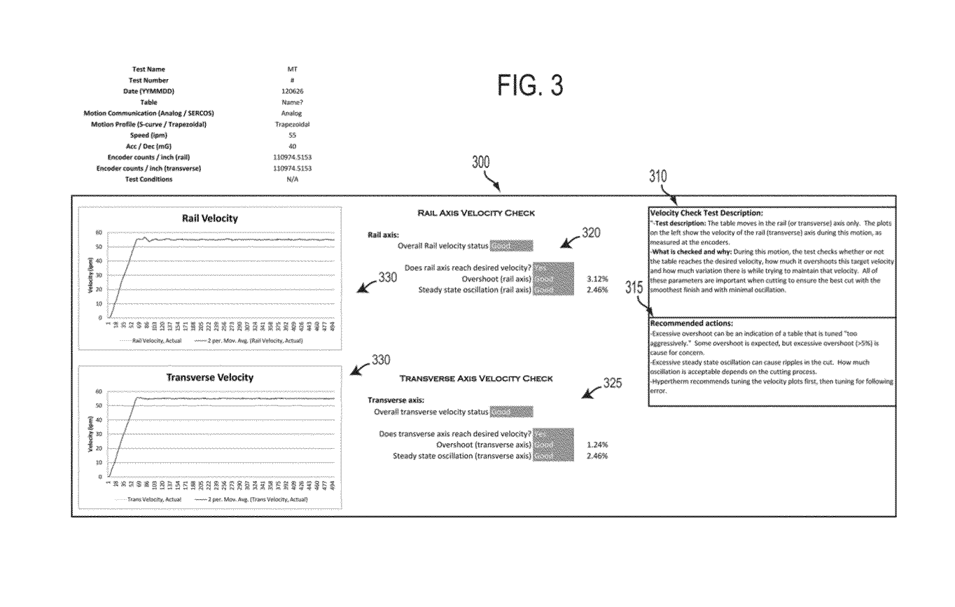

In step 230, the performance measurement is used to generate indicia of a capability of the automated cutting system to perform a desired function. For example, the indicia could include text (e.g., pass, fail, warning, etc.), a color (e.g., red, green, yellow, etc.), an icon (e.g., a circle, triangle, square, etc.), or any combination thereof. See FIG. 3 and Appendix E for further examples. The desired function can be a specified cut, trace, or motion, e.g., manually defined by a user, automatically defined by computing device 160, or otherwise. In some embodiments, the indicia can be a “rating” of the system overall, or of its components (e.g., cutting head, cutting table, etc.). For example, the rating can be “good,” “better,” “best,” and so forth.

In step 235, one or more of the motor outputs for the automated cutting system are adjusted (e.g., automatically by the tool 165, manually by a user, or otherwise) to reduce a deviation between the motor output characteristic and the one or more output commands.

In step 240, a deviation between the motor output characteristic and the one or more output commands can be compensated for by modifying one or more parameters of the automated cutting system. For example, the parameters can include (i) cutting head timing (or “on/off” timing), (ii) process settings (e.g., plasma settings, gas settings, abrasive flow rate, liquid flow rate, etc.), (iii) mechanical settings, (iv) drive and motion settings, (v) nest program settings, (vi) positional motion (either through changing kerf settings, torch height position or commanded position), (vii) commanded angle, (viii) arc voltage for torch height control, (ix) commanded acceleration, (x) commanded speed, or any combination thereof.

Thus, for example, the analysis tool 165 may determine that the cutting head is 0.020″ behind where it is supposed to be (e.g., as indicated by commands 164). Accordingly, the analysis tool 165 can command the cutting head to turn off when the commanded position is 0.020″ beyond where it would be for an “ideal” cutting system (i.e., as indicated by standards 167 or otherwise). By way of further example, if the cutting head, or cutting table, move such that certain features are always 0.003″ smaller than required (e.g., as indicated by standards 167, commands 164, etc.), the analysis tool 165 can command a move that is 0.003″ larger, thus improving the accuracy of the system 100 and components thereof (e.g., cutting head, cutting table, etc.). By way of a further, related example, the analysis tool 165 may have determined that it takes the cutting head 10% longer to perform the cut, trace, or motion, than defined by a specified standard (e.g., command 164, standards 167, etc.). Accordingly, the system 100, or more particularly, the tool 165, can increase the cutting head timing by 10%, i.e., leave the system running for 10% more time.

It will be appreciated that the aforementioned steps 205-240 can be performed in a different order and still achieve desirable results. Moreover, desirable results can also be achieved without performing all of the steps 205-240. For example, in some embodiments, the system can modify a parameter (i.e., step 240) without adjusting motor outputs (i.e., step 235), or vice versa.

Graphical User Interface (GUI)

FIG. 3 shows an exemplary user interface 300 displaying results of a measurement (e.g., according to the process shown in FIG. 2) performed on an automated cutting system (e.g., system 100). More specifically, it shows the measurement (“Velocity Check”) and description 310, recommended actions 315 based on the measurement, the specific results 320, 325 of the measurement, and graphs 330, 335 based on the measurement. As shown, for example, the results can be displayed with a variety (e.g., Good, Bad, Pass, Fail, Yes, No, etc.) of performance indicators. The results 320, 325 can also include a percentage of error (e.g., 3.12%, 2.46%, etc.) based on a particular standard (e.g., standards 167, motor output commands 164, etc.).

Further exemplary displays can be found with reference to Appendix E, attached herewith.

System Hardware and Software

The invention can be implemented in a compact, handheld imaging device, or in a computing system remote from an imaging device. The invention can be implemented in a closed-ended chute including a control wall having an animal feeder, an animal presence indicator and an imaging device having a field-of-view substantially unobstructed by walls of the chute. The implementation can include a control system communicatively connected to the animal presence indicator and the imaging device, and configured to control the imaging device based upon information communicated by the animal presence indicator.

The above-described techniques can also be implemented in digital and/or analog electronic circuitry, or in computer hardware, firmware, software, or in combinations of them. The implementation can be as a computer program product, i.e., a computer program tangibly, embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the technology by operating on input data and/or generating output data. Method steps can also be performed by, and an apparatus can be implemented as, special purpose logic circuitry, e.g., a FPGA (field programmable gate array), a FAA (field-programmable analog array), a CPLD (complex programmable logic device), a PSoC (Programmable System-on-Chip), ASIP (application-specific instruction-set processor), or an ASIC (application-specific integrated circuit). Subroutines can refer to portions of the computer (program and/or the processor/special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage devices suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The computing system can include clients and servers. A client and a server are generally remote from each other and typically interact through a communication network. The relationship of client and server arises by virtue of computer programs running on the respective computers and having a client-server relationship to each other.

The components of the computing system can be interconnected by any form or medium of digital or analog data communication (e.g., a communication network). Examples of communication networks include circuit-based and packet-based networks. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth, code-division multiple access (CDMA) network, time division multiple access (TDMA) network, global system for mobile communications (GSM) network), and/or other circuit-based networks.

Devices of the computing system and/or computing devices can include, for example, a computer, a computer with a browser device, a telephone, an IP phone, a mobile device (e.g., cellular phone, personal digital assistant (PDA) device, laptop computer, electronic mail device), a server, a rack with one or more processing cards, special purpose circuitry, and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). A mobile computing device includes, for example, a Blackberry®. IP phones include, for example, a Cisco® Unified IP Phone 79850 available from Cisco System, Inc, and/or a Cisco® Unified Wireless Phone 7920 available from Cisco System, Inc.

One skilled in the art will realize the invention can be embodied in other specific forms without departing from the spirit or essential characteristics thereof. The foregoing embodiments are therefore to be considered in all respects illustrative rather than limiting of the invention described herein. All changes that come within the meaning and range of equivalency of the claims are therefore intended to be embraced therein. The steps of the invention can be performed in a different order and still achieve desirable results.

It will be appreciated that the illustrated embodiment and those otherwise discussed herein are merely examples of the invention and that other embodiments, incorporating changes thereto, fall within the scope of the invention.

What we claim is:

1. A computerized method for measuring or improving performance of a cutting head of an automated cutting system by evaluating motor control processing of an automated motion control of the cutting head of the automated cutting system, the method comprising:
loading, into a data memory, a set of one or more motor output commands for a plurality of axes of the automated cutting system;
generating one or more motor outputs for the automated cutting system using a first data processor in communication with the data memory, for any of a cut, a trace, or a motion, the one or more motor outputs corresponding to at least a portion of the set of motor output commands;
measuring, using a second data processor, a characteristic of the one or more motor outputs for the plurality of axes of the automated cutting system;
comparing, using a third data processor, the characteristic with the at least a portion of the set of motor output commands; and
determining, with a fourth data processor, a performance measurement of the automated cutting system for evaluating motor control performance thereof, wherein the performance measurement is determined using the comparison of the characteristic and the set of motor output commands.

2. The method of claim 1, further comprising using the performance measurement to generate indicia of a capability of the automated cutting system to perform a desired function.

3. The method of claim 1, further comprising adjusting one or more of the motor outputs for the automated cutting system to reduce a deviation between the motor output characteristic and the one or more output commands.

4. The method of claim 1, further comprising compensating for a deviation between the motor output characteristic and the one or more output commands by modifying one or more parameters of the automated cutting system.

5. The method of claim 3, wherein the one or more parameters include any of (i) cutting head timing, (ii) process settings, (iii) mechanical settings, (iv) drive and motion settings; and (v) nest program settings.

6. The method of claim 1, wherein the motor output characteristic corresponds to any of (i) an acceleration of the cutting head, (ii) a velocity of the cutting head, (iii) a jerk of the cutting head, (iv) a rotation of the cutting head, and (v) a tilt of the cutting head.

7. The method of claim 1, wherein the set of motor output commands are based upon any of (i) a maximum performance of the cutting head, (ii) an average performance of the cutting head, (iii) a desired performance of the cutting head, and (iv) a user-defined performance set.

8. The method of claim 1, wherein the plurality of axes comprises 3, 4, 5 or 6 axes.

9. The method of claim 1, further comprising displaying to a user, via a graphical user interface, any of (i) the performance measurement and (ii) the indicia of the capability of the automated cutting system to perform the desired function.

10. The method of claim 1, wherein the first data processor, second data processor, third data processor and fourth data processor are embodied in a single data processor or a single computing device.

11. A computer readable product, tangibly embodied on non-transitory computer readable medium or a machine-readable storage device and operable on a digital signal processor, for measuring or improving performance of a cutting head of an automated cutting system by evaluating motor control processing of an automated motion control of the cutting head of the automated cutting system, the computer readable product including instructions operable to cause the digital signal processor to:
receive, by the non-transitory computer readable medium or the machine-readable storage device, a set of one or more motor output commands for a plurality of axes of the automated cutting system;
generate, by the non-transitory computer readable medium or the machine-readable storage device, one or more motor outputs for the automated cutting system for any of a cut, a trace, or a motion, the one or more motor outputs corresponding to at least a portion of the set of motor output commands;
measure, by the non-transitory computer readable medium or the machine-readable storage device, a characteristic of the one or more motor outputs for the plurality of axes of the automated cutting system;
compare, by the non-transitory computer readable medium or the machine-readable storage device, the motor output characteristic with the at least a portion of the set of motor output commands;
determine, by the non-transitory computer readable medium or the machine-readable storage device, a performance measurement of the automated cutting system for enhancing motor control performance thereof, wherein the performance measurement is determined using the comparison of the motor output characteristic and the set of motor output commands.

12. The computer readable product of claim 11, further comprising instructions to cause the digital data processor to analyze, by the non-transitory computer readable medium or the machine-readable storage device, the performance measurement to generate indicia of a capability of the automated cutting system to perform a desired function.

13. The computer readable product of claim 11, wherein the non-transitory computer readable medium or the machine-readable storage device includes a tuning tool configured to modify operation of the automated cutting system to compensate for variances between the set of motor output commands and the measured motor output characteristic.

14. The computer readable product of claim 13, further comprising instructions to cause the digital data processor to analyze, by the non-transitory computer readable medium or the machine-readable storage device, the comparison of the motor output characteristic and the set of motor output commands to determine any of (i) a mechanical stability of the cutting head, and (ii) an ability of the cutting head to achieve a desired acceleration or velocity along one or more of the axes.

15. A data processing system for measuring or improving performance of a cutting head of an automated cutting system by evaluating motor control processing of an automated motion control of the cutting head of the automated cutting system, comprising:
a data memory coupled to at least one computing device, wherein the data memory stores a set of one or more motor output commands for a plurality of axes of the automated cutting system;
a calibration engine that executes on the at leas one computing device, wherein the calibration engine
(i) generates one or more motor outputs for the automated cutting system using a first data processor in communication with the data memory, for any of a cut, a trace, or a motion, the one or more motor outputs corresponding to at least a portion of the set of motor output commands;
(ii) measures a characteristic of the one or more motor outputs for the plurality of axes of the automated cutting system;
(iii) compares the characteristic with the at least a portion of the set of motor output commands; and
(iv) determines a performance measurement of the automated cutting system for evaluating motor control performance thereof, wherein the performance measurement is determined using the comparison of the characteristic and the set of motor output commands.

16. The system of claim 15, wherein the calibration engine analyzes the performance measurement to generate indicia of a capability of the automated cutting system to perform a desired function.

17. The system of claim 15, wherein the calibration engine adjusts one or more of the motor outputs for the automated cutting system to reduce a deviation between the motor output characteristic and the set of one or more motor output commands defined by the part data.

18. The system of claim 15, wherein the calibration engine compensates for a deviation between the motor output characteristic and the set of one or more motor output commands defined by the part data.

19. The method of claim 18, wherein the calibration engine compensates for the deviation by modifying one or more values associated with one or more parameters of the automated cutting system.

20. The method of claim 19, wherein the one or more parameters include any of (i) cutting head timing, (ii) process settings, (iii) mechanical settings, and (iv) nest program settings.

21. The system of claim 15, wherein the automated cutting system comprises a plasma cutting system, a laser cutting system, an oxy-fuel cutting system, a high temperature thermal cuttings system, a drilling system, a punch system, or a fluid jet cutting system.
